(19) United States
(12) Patent Application Publication
(10) Pub. No.: US 2024/0001300 A1
(43) Pub. Date: Jan. 4, 2024

(54) METHOD AND COMPOSITION FOR LIQUID-LIQUID EXTRACTION

(71) Applicant: Molten Salt Solutions, LLC, Santa Fe, NM (US)

(72) Inventors: Stephen L. Yarbro, Corrales, NM (US); Gordon Dennis Jarvinen, Marana, AZ (US); Joe M. Gatewood, Santa Fe, NM (US); John W. Elling, Santa Fe, NM (US)

(73) Assignee: Molten Salt Solutions, LLC, Santa Fe, NM (US)

(21) Appl. No.: 18/344,396

(22) Filed: Jun. 29, 2023

Related U.S. Application Data
(60) Provisional application No. 63/356,920, filed on Jun. 29, 2022.

(51) Int. Cl. B01D 59/24; C01D 15/00

(52) U.S. Cl. CPC B01D 59/24; C01D 15/00

(57) ABSTRACT

A composition for extracting a metal, the composition comprising an organic phase comprising a crown either, an organic solvent, and an organic phosphate. The crown either may comprise B15C5 crown and the organic solvent may comprise chloroform and/or toluene. The organic phase may further comprise an alcohol. A method for extracting a metal, the method comprising disposing an organic phase comprising a crown either, an organic solvent, and an organic phosphate; and an aqueous phase comprising a metal salt and a base into a high-speed countercurrent chromatograph. The metal may comprise a lithium ion.

### CROSS-REFERENCE TO RELATED APPLICATIONS

This application claims priority to and the benefit of the filing of U.S. Provisional Patent Application No. 63/356,920, entitled “METHOD AND COMPOSITION FOR LITHIUM ISOTOPE EXTRACTION”, filed on Jun. 29, 2022, and the specification thereof is incorporated herein by reference.

### STATEMENT REGARDING FEDERALLY SPONSORED RESEARCH OR DEVELOPMENT

This invention was made with government support under National Science Foundation Award No. 2036545 awarded by the National Science Foundation. The government has certain rights in the invention.

### BACKGROUND OF THE INVENTION

### Field of the Invention (Technical Field)

The present invention is related to the enrichment of isotopes via a liquid-liquid extraction process. The invention of the present disclosure also relates to a method for liquid-liquid chromatography enrichment of a lithium isotope comprising contacting the lithium isotope with a phosphonate extractant.

### DESCRIPTION OF RELATED ART

Note that the following discussion may refer to a number of publications and references. Discussion of such publications herein is given for more complete background of the scientific principles and is not to be construed as an admission that such publications are prior art for patentability determination purposes.

Lithium isotope enrichment allows the production of lithium with a different ratio of the two stable isotopes Li-6 and Li-7 than that found in natural sources that is near 92.4% Li-7 and 7.6% Li-6. The enriched lithium isotopes have various current and potential commercial and national security applications. One of the best studied liquid-liquid extraction processes for lithium isotope enrichment uses crown ethers that preferentially extract Li-6 into an organic phase from an aqueous solution of LiCl or other lithium salts such as LiBr, Lil, LiSCN, and LiClO₄. The purpose of the organic extractant in liquid-liquid extraction methods is to increase the solubility of the lithium in the organic phase and to do this in a way that is isotopically selective. The preferred crown ether extractant is a benzo-15-crown-5 ether (B15C5) although other crowns have been tested as well.

Crown ether extractants are expensive chemicals and so extraction methods are costly to implement commercially. An organic solvent most often used in conjunction with crown ether extractants is 100% chloroform. 100% nitrobenzene has also been considered. These solvents are fairly polar, which enables high concentrations of dissolved crown ether to be used to increase the throughput of lithium in the separation process. Only single organic solvents have been used in conjunction with crown ether extractants. Furthermore, chloroform has been used only in the organic phase. Chloroform is cheap to buy but very expensive to use due to the waste cleanup and environmental protocol. Chloroform is a category 2 irritant and a category 4 inhaled toxin. Waste streams in contact with chloroform must be carefully treated prior to discharge. However, the crown ether extractant may be lost to the aqueous phase of a liquid-liquid extraction.

Acidic organophosphorous-based extractants have been established in the mining industry for solvent separation processes. These extractants have not previously exhibited significant isotopic selectivity for lithium. Tests for isotopic enrichment with this class of extractants have previously used single-salt aqueous phases.

High-speed countercurrent chromatography (HSCCC) is a method of implementing a liquid-liquid extraction separation that uses a system of coiled tubing on ‘bobbins’ that rotate on their axis as they rotate around a central axis. As the bobbins rotate, the direction and magnitude of the centrifugal force changes and forces immiscible fluids to mix and separate many times as the two fluids flow through the coiled tubing. Each mixing and separation event allows mass to transfer from one fluid to the other depending on the partition coefficient. One mode of operation loads a stationary liquid phase into the tubing and then pumps a flow of the other liquid phase through the system while it is spinning. Conventionally, the denser phase is stationary, and the less dense phase is mobile. In a single-flow implementation, samples are processed by introducing them as plugs of the mobile phase flow through the stationary phase and are collected as they emerge from the HSCCC with a fraction collector. Another mode of operation allows both fluid phases to flow past each other by introducing the phases into opposite ends of the spinning column through smaller feed tubes inside the larger column tubing and allowing the immiscible fluids to interact as they move in opposite directions through the column.

HSCCC may be used to efficiently enrich lithium isotopes. However, a rapid settling time between the two phases is required for extraction methods to be compatible with HSCCC. Settling time is the time required for the two phases to separate into distinct layers after being mixed. A settling time of 10 to 20 seconds is optimum for compatibility with the HSCCC method.

Solvent extraction of metal ions has been accomplished. These liquid-liquid extraction methods typically include metal salts dissolved in the aqueous phase and require organic compounds (extractants) that increase the solubility of the metal ions in the organic phase. These organic extractants have physical properties that can increase the settling time between the two phases significantly, to the point of incompatibility with HSCCC implementation. Solvent extraction of metal ions that are selective for various isotopes of the metal are known.

Liquid-liquid extraction (also called solvent extraction) is a method for separating components of a solution by utilizing an unequal distribution of the components between two immiscible liquid phases. The separation process consists of the transfer of a solute from one solvent to another, the two solvents being immiscible or only partially miscible with each other. Frequently, one of the solvents is water or an aqueous mixture and the other is a nonpolar organic liquid. Liquid-liquid extraction comprises a step of mixing (contacting), followed by a step of phase separation.

In most cases, this process is carried out by intimately mixing the two immiscible phases, allowing for the selective transfer of solute(s) from one phase to the other, then allowing the two phases to separate. Typically, one phase will be an aqueous solution, usually containing the components to be separated, and the other phase will be an organic solvent, which has a high affinity for some specific components of the solution. The process is reversible by contacting the solvent loaded with solute(s) with another immiscible phase that has a higher affinity for the solute than the organic phase. The transfer of solute from one phase into the solvent phase is referred to as extraction and the transfer of the solute from the solvent back to the second (aqueous) phase is referred to as back-extraction or stripping. The two immiscible fluids must be capable of separating after being mixed together, and this is a function of the differences in chemical properties between the two phases such as dielectric constant and density.

Liquid-liquid extractions are performed with a variety of equipment used to mix the immiscible phases together and then separate them. This equipment includes pulsed columns, mixer settlers, centrifugal contactors, and high-speed countercurrent chromatography.

One optimum liquid-liquid extraction of lithium isotopes method is using 1 molar (“M”) B15C5 in chloroform as the organic phase and 12 M LiCl salt as the aqueous phase. The settling time of this phase composition was observed to be 263 seconds. This settling time is too long to be useful in an HSCCC system. Liquid-liquid extraction systems employing crown ethers intrinsically tend to have a large settling time due to the detergent effect of the crown.

Acidic organophosphorous-based extractants have been established in the mining industry for solvent separation processes for metal ions. These extractants have not previously exhibited significant isotopic selectivity. Tests for isotopic enrichment with this class of extractants have previously used single-salt aqueous phases. Many acidic organophosphorous extractants also have strong detergent properties and can have long settling times.

To implement metal extractions and isotopically-selective metal extractions in liquid-liquid extraction methods employing organic extractants with HSCCC, methods are necessary to reduce the settling time. In addition to lithium isotope separation the application of these extractants to other metal isotope separations is likely such as zinc, zirconium, and gadolinium.

What is needed is a less expensive extractant for the enrichment of lithium isotopes and a method by which to reduce the settling time of liquid-liquid extraction of lithium isotope systems based on crown ethers to improve compatibility with HSCCC.

### BRIEF SUMMARY OF THE INVENTION

Embodiments of the present invention relate to a composition for extracting a metal, the composition comprising: an organic phase; the organic phase comprising: a crown ether; an organic solvent; and an organophosphate. In another embodiment, the crown ether comprises B15C5 crown. In another embodiment, the crown ether comprises 4-tert-butylbenzo-15-crown-5. In another embodiment, the crown ether comprises a t-butyl derivative of said B15C5 crown. In another embodiment, the organic solvent comprises chloroform. In another embodiment, the organic solvent comprises toluene. In another embodiment, the toluene is at a concentration of 5% to 20% by volume. In another embodiment, the organic solvent comprises heptane. In another embodiment, the organic solvent comprises 1,2-dichlorobenzene.

In another embodiment, the organophosphate comprises a liquid phosphine oxide. In another embodiment, the organophosphate comprises Cyanex 936P. In another embodiment, the organophosphate comprises di-2-ethylhexylphosphoric acid. In another embodiment, the composition further comprises an alcohol. In another embodiment, the alcohol comprises 1-pentanol. In another embodiment, the composition further comprises an aqueous phase wherein said aqueous phase comprises: a metal salt; and a base. In another embodiment, the metal salt comprises a lithium salt. In another embodiment, the base comprises ammonia.

The present invention also relates to a method for extracting a metal, the method comprising: at least partially disposing an organic phase into a high-speed countercurrent chromatograph, wherein the organic phase comprises: a crown ether; an organic solvent; and an organophosphate; at least partially disposing an aqueous phase into the high-speed countercurrent chromatograph, wherein the aqueous phase comprises: a metal salt; and a base; at least partially disposing a sample comprising a metal into the high-speed countercurrent chromatograph; contacting the organic phase with the aqueous phase; and extracting the metal from the aqueous phase into the organic phase. In another embodiment, the metal comprises a lithium ion. In another embodiment, the crown ether comprises B15C5 crown.

Further scope of applicability of the present invention will be set forth in part in the detailed description to follow, taken in conjunction with the accompanying drawings, and in part will become apparent to those skilled in the art upon examination of the following, or may be learned by practice of the invention.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is a graph showing the effect of toluene in an organic solvent;

FIG. 2 is diagram is prior art showing the functional mechanism of HSCCC;

FIG. 3 is a graph showing Li distribution v. LiCl concentration; and

FIG. 4 is a graph showing LiSCN extraction with 100% chloroform and a mixture of 83% chloroform and 17% toluene.

### DETAILED DESCRIPTION OF THE INVENTION

The invention of the present disclosure relates to the development of a liquid-liquid extraction organic phase composition for separating metal ions that is compatible with processing with a high-speed countercurrent chromatography system. The invention of the present disclosure also relates to a method for liquid-liquid extraction enrichment of a lithium isotope comprising contacting the lithium isotopes with a crown ether or organophosphonate extractant system.

The composition and method of the present invention also relate to organic phase compositions for lithium isotope extraction to improve compatibility with HSCCC and to phosphonate extractants for enriching a lithium isotope using liquid-liquid extraction. Embodiments of the present invention are described below.

The method of liquid-liquid chromatography enrichment of a lithium isotope may comprise providing a basic aqueous phase. The basic aqueous phase may also comprise LiOH and/or a Li salt with an added base such as ammonia, methylamine, dimethyl amine, trimethyl amine, tetramethylammonium hydroxide, potassium hydroxide, sodium hydroxide, cesium hydroxide, lithium bicarbonate, sodium bicarbonate, potassium bicarbonate, or cesium bicarbonate, lithium carbonate, sodium carbonate, potassium carbonate, or cesium carbonate. The method may comprise contacting Li and/or a Li compound with an organic phase preferably comprising an organic solvent and a phosphonate to extract the Li and/or Li compound. The phosphonate may comprise an organic phosphonate. The method may further comprise contacting Li and/or a Li compound with an organic phase comprising a straight chain and/or branched chain hydrocarbon. The organic phase may further comprise an alcohol. The method may further comprise passing the basic aqueous phase and organic phase into an HSCCC apparatus.

The composition and method of the present invention may be a less expensive extractant for the enrichment of lithium isotopes than other compositions methods. The composition and method of the present invention may also reduce the settling time of liquid-liquid extraction of lithium isotope systems based on crown ethers compared to other compositions and methods. The composition and method of the present invention may also to improve lithium isotope enrichment compatibility with HSCCC.

The terms “liquid-liquid extraction” or “solvent extraction” as referred to herein mean a method for separating components of a solution using an unequal distribution of the components between two immiscible liquid phases.

The term “liquid-liquid chromatography” as referred to herein means a separation technique the separation and analysis of a substance including water-soluble and oil-soluble compounds, ionic and nonionic compounds, and biopolymers wherein molecules of a substance are dispersed between two immiscible liquid phases, a stationary phase and a mobile phase.

The terms “high-speed countercurrent chromatography” or “HSCCC” as referred herein mean a method of implementing a liquid-liquid extraction separation that uses a system of coiled tubing on members that rotate on their individual axes and which simultaneously rotate around a central axis.

The terms “B15C5 crown” or “B15C5” as referred to herein mean the compound benzo-15-crown-5. The terms “B15C5 crown” and “B15C5” are used interchangeably.

The terms “crown ether” and “crown” as referred to herein mean a cyclic polyethers comprising four or more oxygen atoms each separated by two or three carbon atoms. The terms “crown ether” and “crown” are used interchangeably.

The term “metal” or “metals” is defined in the specification and claims as a compound, mixture, or substance comprising a metal atom. The term “metal” or “metals” includes, but is not limited to, metal hydroxides, metal oxides, metal salts, elemental metals, metal ions, non-ionic metals, minerals, or a combination thereof. The metals may comprise, but are not limited to, RE metals. The selectively recovered metals may comprise, but are not limited to, neodymium (“Nd”), praseodymium (“Pr”), dysprosium (“Dy), copper (“Cu”), lithium (“Li”), sodium (“Na”), magnesium (“Mg”), potassium (“K”), calcium (“Ca”), titanium (“Ti”), vanadium (“V”), chromium (“Cr”), manganese (“Mn”), iron (“Fe”), cobalt (“Co”), nickel (“Ni”), cadmium (“Cd”), zinc (“Zn”), aluminum (“Al”), silicon (“Si”), silver (“Ag”), tin (“Sn”), platinum (“Pt”), gold (“Au”), bismuth (“Bi”), lanthanum (“La”), europium (“Eu”), gallium (“Ga”), scandium (“Sc”), strontium (“Sr”), yttrium (“Y”), zirconium (“Zr”), niobium (“Nb”), molybdenum (“Mo”), ruthenium (“Ru”), rhodium (“Rh”), palladium (“Pd”), indium (“In”), hafnium (“Hf”), tantalum (“Ta”), tungsten (“W”), rhenium (“Re”), osmium (“Os”), iridium (“Ir”), mercury (“Hg”), lead (“Pb”), polonium (“Po”), cerium (“Ce”), samarium (“Sm”), erbium (“Er”), ytterbium (“Yb”), thorium (“Th”), uranium (“U”), plutonium (“Pu”), terbium (“Tb”), promethium (“Pm”), tellurium (“Te”), or a combination thereof.

The organic phase may comprise a crown ether extractant. The crown ether extractant may comprise, but is not limited to, 1,4,7,10-tetraazacyclododecane (Cyclen), 12-crown-4, benzo-12-crown-4, benzo-18-crown-6, benzo-15-crown-5, dibenzo-24-crown-8, dibenzo-18-crown-6, 18-crown-6, dibenzo-30-crown-10, 15-crown-15, 1-aza-18-crown-6, nitrobenzo-18-crown-6, nitrobenzo-15-crown-5, 1-aza-15-crown-5, perfluoro-15-crown-5, 2,3-naphtho-15-crown-5, or a combination thereof.

Increasing the hydrophobicity of a crown ether extractant may improve settling time. A t-butyl derivative of the B15C5 crown, 4-tert-butylbenzo-15-crown-5, may comprise a higher distribution coefficient than B15C5 while retaining a high lithium isotope separation factor. The crown ether extractant structure may be designed to reduce the crown ether extractant solubility in the aqueous phase. Reducing the crown ether extractant solubility may improve the economic efficiency of the extraction process using the crown ether extractant. Derivatives of the B15C5 crown that reduce the crown solubility in the aqueous phase may reduce settling time.

The concentration of a B15C5 extractant may reduce the settling time. Reducing the crown concentration of at least about 0.5 M in chloroform from 1.0 M or more may reduce the settling time when extracting LiSCN aqueous solutions in the concentration range of about 4 M to about 5 M. The settling time may be reduced by at least about 1 second, about 1 second to about 20 seconds, about 2 seconds to about 18 seconds, about 4 seconds to about 16 seconds, about 6 seconds to about 14 seconds, about 8 seconds to about 12 seconds, or about 20 seconds.

Mixtures of organics other than 100% chloroform may be used as the solvent for the B15C5 crown. A second solvent in the solvent mixture may be less polar (more hydrocarbon-like) but still allow crown solubility in the organic phase. Other mixtures of organic solvents may be used with the crown ether extractants to achieve reductions in settling time.

The organic phase composition containing the crown ether may comprise chloroform and toluene. The percentage of chloroform may be at least about 83%, about 83% to about 99%, about 85% to about 97%, about 90% to about 95%, or about 99% volume concentration of the solute in solution (“v/v”). The percentage of toluene may be at least about 1%, about 1% to about 20%, about 5% to about 15%, about 10% to about 12%, or about 20% v/v.

The solvent mixture may comprise at least one component in which the crown is significantly soluble, for example chloroform and/or nitrobenzene. At least one component that lowers the surfactant property of the dissolved crown ether may be included. Such component may comprise any aromatic solvent including, but not limited to, toluene.

Alternative lithium salt anions may be used in the B15C5 crown ether extraction method. Lithium thiocyanate (LiSCN) may be used to replace LiCl in the aqueous salt phase. Improved phase settling times may be achieved with LiSCN. LiSCN may be at a concentration of at least about 2.0 M, about 2.0 M to about 5.0 M, about 2.5 M to about 4.5 M, about 3.0 M to about 4.0 M, or about 5.0 M. Lithium salts with other anions that are larger and less polar than chlorine and hydroxide may achieve similar improvements in settling time due lower salt concentration relative to chloride needed to obtain a favorable extraction coefficient for lithium. This may lower the extraction of the crown ether into the aqueous phase, decreasing the detergent action of the crown.

Improvements in settling time may result from the lower solubility of the crown ether extractant in the aqueous salt phase. Any reduction in the concentration of crown ether extractant in the aqueous phase will reduce the detergent effect of the crown ether and so improve the settling time.

The aqueous phase may comprise water and a metal salt. The metal salt may have the formula MX where M is a metal and X is any anion. The metal salt may be a lithium salt LiX where X is any anion and may include, but is not limited to, Br⁻, ClO₄⁻, SCN⁻, Cl⁻, HCO₃²⁻, OH⁻, FeCl₄⁻, I⁻, PF₆⁻, CH₃CO₂⁻, CF₃CO₂⁻, PhCO₂⁻, or a combination thereof. The aqueous salt phase may also comprise water and a lithium salt and a second salt wherein the second salt comprises an anion that facilitates the formation of an aqueous ion pair. The aqueous ion pair may facilitate transfer of lithium cations into the organic phase. For example, a mixture of LiCl and iron chloride (FeCl₃) may generate the salt complex lithium tetrachloridoferrate (LiFeCl₄) and a mixture of LiSCN and Fe(SCN)₃ many generate LiFe(SCN)₄ that can extract into the organic phase.

Settling times less than the target may be achieved with a LiCl aqueous phase salt concentration of about 8 M or less, or at least about 0.5 M, about 0.5 M to about 10 M, about 1 M to about 9 M, about 2 M to about 8 M, about 3 M to about 7 M, about 4 M to about 6 M, or about 10 M, in conjunction with other modifications of the aqueous phase. Lower salt concentration may be used if higher concentrations increase the solubility of the crown in the aqueous phase.

A phosphonate extractant may be contacted with an isotope in a liquid-liquid extraction for isotopic enrichment. The isotopic enrichment may comprise lithium isotopic enrichment. This composition may comprise a mixture of salts in the aqueous phase. At least one reagent in the aqueous phase may generate basic conditions (pH above 7 and preferably above 9) and at least one reagent may provide lithium ions that partition into the organic phosphonate-containing phase. A liquid-liquid chromatography method using a phosphonate extractant may be performed in conjunction with an HSCCC.

A metal-specific phosphonate extractant may be used to recover metal including, but not limited to, lithium. The phosphonate extractant may comprise a liquid phosphine oxide, including, but not limited to, Cyanex 936P, which is specific to lithium. An isotope effect may be achieved for lithium extractions with a liquid phosphine oxide. The phosphonate extractant may be acidic.

The phosphonate extractant may improve settling time with solvent mixtures. A solvent and/or solvent component may provide solubility to the phosphonate extractant. The solvent and/or solvent component may comprise any single chain or branched chain hydrocarbon including, but not limited to, dodecane, octane, heptane, hexane, or a combination thereof.

The solvent and/or solvent component of the solvent mixture may mitigate the detergent properties of the phosphorous extractant. The solvent mixture may comprise an alcohol including, but not limited to, 1-pentanol, 1-octanol, 1-heptanol, or a combination thereof. Organophosphates including, but not limited to, Cyanex 936P, di-2-ethylhexylphosphoric acid (“HDEHP” or “D2EHPA”), Cyanex 272, dibutylphosphate, diphenylphosphate, dibenzylphosphate, diphenylphosphinic acid, or a combination thereof, may form dimers in hydrocarbon solvents that may be hydrogen bonded together through an acidic POH and a P═O group. Dimers and larger aggregates may also form when metal ions are extracted into the organic phase. An organic soluble alcohol including, but not limited to, 1-pentanol, 1-octanol, 1-heptanol, or a combination thereof, may break up these dimers and aggregates by providing hydrogen bonding sites that are not from the organophosphorus extractant. For example, the solvent may comprise about 30 vol % 1-pentanol in heptane. The solvent with phosphorous extractant may comprise about 28% vol % a liquid phosphine oxide, including, but not limited to, Cyanex 936P, dissolved in a solvent of 70 vol % heptane and 30 vol % 1-pentanol.

A mixture of compounds in the aqueous phase may enable both the distribution of lithium into the organic phase and selective distribution of a lithium isotope into an organic phase. At least one of the components in the aqueous phase may establish a high pH so that extraction can occur. When lithium and/or a lithium ion goes into the organic phase and complexes with the extractant, the proton from the phosphoric acid group may be accepted into the aqueous phase. Extraction of monovalent metal ions including, but limited to, Li⁺ with organophosphates occurs when the aqueous phase is basic. The aqueous phase may comprise a lithium compound including, but not limited to, LiOH. Another compound in the aqueous phase may be a compound able to create a high pH buffer including, but not limited to ammonia, methylamine, dimethyl amine, trimethyl amine, tetramethylammonium hydroxide, potassium hydroxide, sodium hydroxide, cesium hydroxide, lithium bicarbonate, sodium bicarbonate, potassium bicarbonate, or cesium bicarbonate, lithium carbonate, sodium carbonate, potassium carbonate, or cesium carbonate, or a combination thereof. The concentration of the base, e.g., KOH, NH₃, or combinations thereof, may be sufficient to maintain a basic pH during the extraction. The concentration of the base may be fractionally higher than the lithium molarity saturation in the organic layer so that the pH does not limit the extraction process.

With Cyanex 936P at 28% v/v in an organic solvent, the molarity of the base of the aqueous phase may be above at least about 0.2 M, about 0.2 M to about 0.3 M, about 0.21 M to about 0.29 M, about 0.22 M to about 0.28 M, about 0.23 M to about 0.27 M, about 0.24 M to about 0.26 M, or about 0 . . . M. Excess base may be undesirable because high salt concentrations will increase settling times.

The aqueous phase composition may comprise a salt selected to provide a lithium concentration in the aqueous phase at least twice the expected saturation concentration of the lithium in the organic phase. The salt may include, but is not limited to, LiX where X is any anion including OH⁻, Br⁻, ClO₄⁻, SCN⁻, Cl⁻, HCO₃⁻, CO₃²⁻, OH⁻, FeCl₄⁻, I⁻, PF₆⁻, CH₃CO₂⁻, CF₃CO₂⁻, PhCO₂⁻, or a combination thereof.

Aqueous phase extraction into the phosphonate-containing organic phase may occur when the aqueous phase pH is above about 7. Back-extracting the lithium from the organic phase may require the aqueous phase to be acidic.

The aqueous mobile phase used in an HSCCC method may comprise segments of a salt comprising lithium at a high pH from which lithium ions may be extracted, followed by mobile phase aqueous segment with no lithium at a low pH. Lithium ions may be back-extracted from the organic phase into the mobile phase aqueous segment. A gap of distilled water between the salt plugs and the back-extraction plugs may be used to achieve optimal isotope fractionation.

The isotope enrichment method of the present invention comprises processing a pure lithium salt solution. Phosphonate extractants may be used to provide superior alphas, distributions, and settling times for lithium isotope extraction and/or enrichment. Solvent extraction of lithium and/or a lithium isotope may comprise contacting lithium and/or a lithium isotope with reagent including, but not limited to, Cyanex 936P, HDEHP, Cyanex 272, dibutylphosphate, diphenylphosphate, dibenzylphosphate, diphenylphosphinic acid, or a combination thereof.

Increasing the concentration of lithium in the aqueous phase may increase the amount of lithium in the organic phase. Lower temperature may improve Li distribution. The concentration of Li may increase in the organic phase by at least about 5%, about 5% to about 20%, about 10% to about 15%, or about 20% at about 5° C. compared to about 25° C. Toluene in the organic phase may significantly lower Li distribution, e.g., by at least about 35%, about 35% to about 60%, about 40% to about 55%, about 45% to about 50%, or about 60%, of lithium from the LiCl aqueous phase. However, toluene may not have a significant effect on distribution of lithium from LiSCN and may result in a slight improvement.

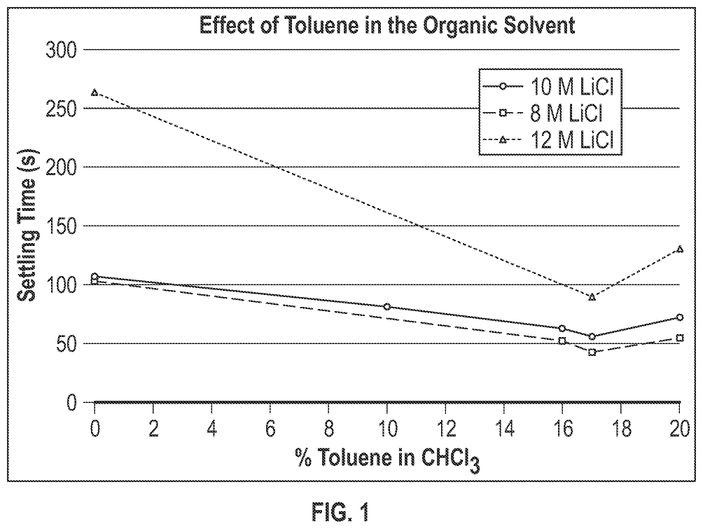

Turning now to the figures, FIG. 1 shows the impact on toluene concentration on an organic solvent and its effect on settling time. Settling time decreases with increasing toluene percentage in chloroform for 8 M, 10 M, and 12 M LiCl until about 17% toluene. The settling time increases if the toluene percentage is increased beyond 17%.

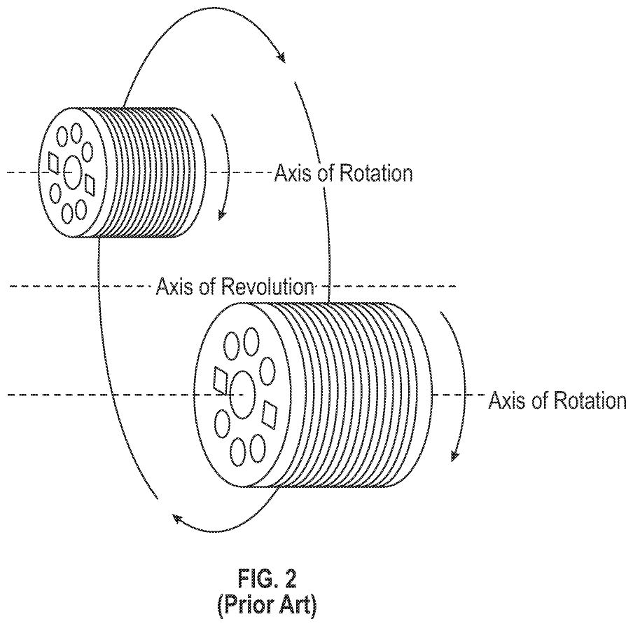

FIG. 2 shows the functional mechanism of HSCCC. The HSCCC may comprise one or more bobbins. The HSCCC apparatus rotates around an axis of revolution and the bobbins also rotate on their own axes. Each bobbin revolves around the central shaft while simultaneously rotating about its own axis.

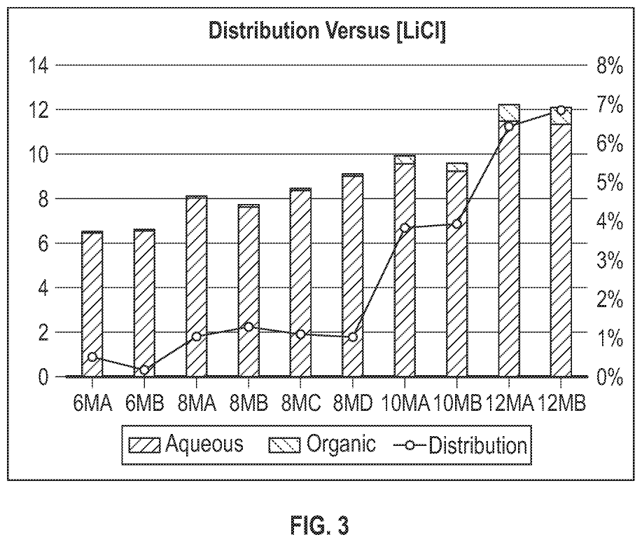

FIG. 3 shows the lithium distribution as a function of LiCl concentration in an aqueous phase at room temperature. The distribution of the lithium in the organic phase is shown on the secondary axis.

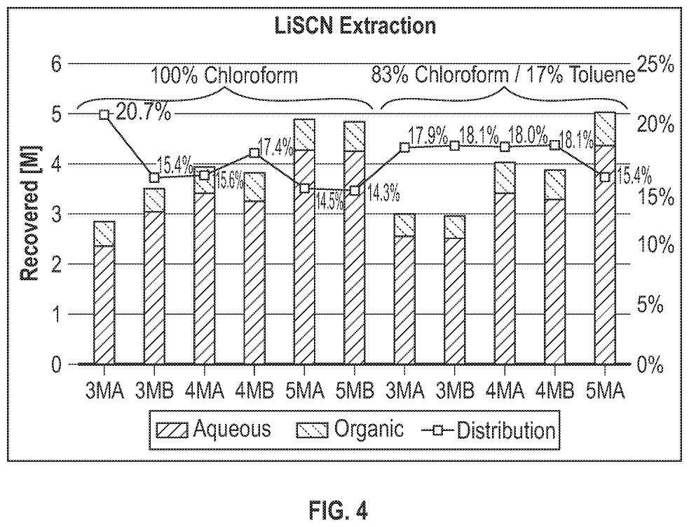

FIG. 4 shows lithium thiocyanate extraction versus lithium thiocyanate concentration and solvent composition. Lithium thiocyanate aqueous solutions instead of lithium chloride solutions may result in better phase properties and may facilitate HSCCC extraction. The graph shows lithium thiocyanate at 3 M, 4 M, and 5 M. Both 100% chloroform and 83% chloroform with 17% toluene (v/v) with 1.0 M B15C5 were used for LiSCN extraction.

Embodiments of the present invention provide a technology-based solution that overcomes existing problems with the current state of the art in a technical way to satisfy an existing problem for decreasing the cost and increasing the efficiency of lithium isotope extraction. Embodiments of the present invention achieve important benefits over the current state of the art including, but not limited to, more economical, faster, and more efficient lithium isotope extraction. Some of the unconventional steps of embodiments of the present invention include lithium isotope extraction using an organic solvent comprising toluene and chloroform and lithium isotope extraction using an organophosphonate extractant.

Some of the unconventional steps of embodiments of the present invention include the use of lithium and other salt mixtures in the aqueous phase in order to maximize isotope selectivity. Other unconventional steps of the embodiment of the present invention include using an organic phase comprising a mixture of organic compounds in order to minimize the separation time of the organic and aqueous phases.

### ADDITIONAL EXAMPLES

The invention is further illustrated by the following non-limiting examples.

### Example 1

Mixtures of toluene and chloroform were tested for Li extraction. An 83% chloroform and 17% toluene organic solvent mixture (v/v) with 1 M B15C5 crown ether provided the fastest settling time across the tested range of toluene mixtures and LiCl salt concentrations. For example, with the extractions of the 10 M LiCl salt mixtures, the toluene and chloroform organic solvent mixture provided a 56-second settling time compared to the 107-second settling time with pure chloroform. In this series, an aqueous phase of 1 M B15C5 in 17% toluene and 83% chloroform and an organic phase of 8 M LiCl had the best settling time, which was measured to be 43 seconds.

### Example 2

An aqueous phase of 4.0 M LiSCN salt with 1.0 M B15C5 in 100% chloroform solvent extractant was tested for settling time. The aqueous phase of 4.0 M LiSCN salt had a second settling time when extracted with 1.0 M B15C5 in 100% chloroform solvent. The lithium distribution of this extraction was measured to be about 0.18. The single stage alpha of this phase mixture was measured to be 1.022. The addition of 17% toluene to the organic solvent lowered the settling time to 46 seconds.

### Example 3

An aqueous phase of 4.0 M LiSCN salt with 0.5 M B15C5 in 100% chloroform solvent extractant was tested for settling time. An aqueous phase of 4.0 M LiSCN salt had a 35-second settling time when extracted with 0.5 M B15C5 in 100% chloroform. The lithium distribution of this extraction was measured to be approximately 0.05. The single stage lithium isotope separation alpha averaged 1.082 across 6 experiments.

### Example 4

Eight molar LiCl with a toluene and chloroform solvent mix and 1.0 M B15C5 crown exhibited was tested. The solvent mix achieved a 43-second settling time, which was the lowest observed for the LiCl salt solution aqueous phase.

### Example 5

The isotopic selectivity of the Cyanex 936P extraction was tested in conjunction with the aqueous salt composition. A significant isotopic selectivity was observed when extracting more concentrated aqueous solutions that contained both LiOH and LiCl lithium salts. These alphas of greater than 1.04 are significantly better than the approximately 1.03 alphas achieved with the crown-based extractants. Table 1 shows the alphas, settling times, and distributions of a selection of the large matrix of aqueous phases that were tested in extractions with 28% Cyanex 936P in dodecane. The unfavorable alphas of the LiOH tests and the unfavorable distributions of the LiCl tests are highlighted. The significant alphas of the aqueous salt mixtures are also highlighted.

TABLE 1
LiOH and LiCL extractions with 28% Cyanex 936P in dodecane.

| | | post | | |
|---|---|---|---|---|
| | | extraction | settling | |
| Aqueous salt | alpha | pH | time (s) | distribution |
| 1.0M LiOH | 1.001 | 13.5 | 56 | 0.26 |
| 0.8M LiOH | 1.008 | 13.5 | 49 | 0.34 |
| 0.5M LiOH | 1.018 | 13.5 | 206 | 0.69 |
| 0.15M LiCl | 1.026 | 5.5 | 75 | 0.017 |
| 0.2M LiCl | 1.016 | 5.5 | 47 | 0.0015 |
| 0.24M LiCl | 1.016 | 5.5 | 60 | 0 |
| 0.4M LiOH, | | | | |
| 0.4M LiCl | 1.050 | 13.5 | 74 | 0.16 |
| 0.6M LiOH | | | | |
| 0.2M LiCl | 1.041 | 13.5 | 109 | 0.14 |

For examples 6 to 8, below, the amount of lithium that entered into the organic phase from the aqueous phase as a function of various factors was assessed. The various factors included, lithium salt species, lithium salt concentration, pH, organic phase composition, organic phase extractant, temperature, and crown ether species.

### Example 6

A baseline organic phase was prepared. The baseline was 1 M B15C5 crown ether in chloroform. The aqueous phase was various concentrations of LiCl in distilled water. Two milliliters of aqueous and 2 ml of organic were pipetted into a 10 ml centrifuge tube and shaken at an angle for 20 minutes. The tubes were then centrifuged for 10 minutes and approximately one ml of each phase was pipetted off. The organic phase was back-extracted with 0.1 M HCl solution twice in order to assess the amount of lithium contained in the organic phase. Duplicates were prepared and run for each tested condition. Samples of the back-extracted organic phase and the aqueous phase were diluted, and the lithium concentrations measured with flame-atomic absorption. Substantial dilution was required to get the lithium concentrations low enough to measure with the flame-AA. An additional shake time of 40 minutes instead of 20 minutes did not significantly change the 8 M distribution coefficient of about 0.01%.

### Example 7

Effect of temperature on Li distribution was tested. The experiments above were replicated with the extractions run at 5° C. Lower temperature improved the distribution as shown in Table 2. Superscript numbers next to concentration indicate number of duplicate samples.

TABLE 2
Effect of temperature on Li distribution.

| | Samples | | |
|---|---|---|---|
| | 25° C. | 5° C. | TOPO |
| | distribution | | |
| 6 M | 0.472% | 1.232% | 0.000% |
| Test 1 | | | |
| 6 M | 0.141% | 0.911% | 0.000% |
| Test 2 | | | |
| 8 M | 0.969% | 7.013% | 1.258% |
| Test 1 | | | |
| 8 M | 1.242% | 3.507% | 1.240% |
| Test 2 | | | |
| 10 M | 3.795% | 6.232% | 3.786% |
| Test 1 | | | |
| 10 M | 3.895% | 5.931% | 4.223% |
| Test 2 | | | |
| 12 M | 6.395% | 7.198% | 5.705% |
| Test 1 | | | |
| 12 M | 6.813% | 7.331% | 6.058% |
| Test 2 | | | |

### Example 8

The LiCl distribution in chloroform and 17% toluene was tested with 1 M B15C5 crown ether extractant. Modification of the organic phase was tested to improve (decrease) the phase disengagement time. An organic phase solvent system consisting of 83% chloroform and 17% toluene (v/v) was selected. The distribution of lithium between this modified organic phase and the aqueous phase was tested as a function of LiCl concentration and temperature. Shake tests were run as described in Example 6. The results are shown in Table 3, with the room temperature results from Table 1 copied for reference. Toluene in the solvent significantly lowered the distribution of lithium from the LiCl aqueous phase. Superscript numbers next to concentration indicate number of duplicate samples.

TABLE 3
Distribution of lithium in a modified organic
phase of 83% chloroform and 17% toluene.

| | | Room | |
|---|---|---|---|
| | 100% | Temp | |
| | CHCl₃ | ~25° C. | 5° C. |
| 6 M | 0.47% | 0.06% | 0.23% |
| Test 1 | | | |
| 6 M | 0.14% | 0.06% | 0.21% |
| Test 2 | | | |
| 8 M | 0.97% | 0.45% | 0.75% |
| Test 1 | | | |
| 8 M | 1.24% | 0.45% | 0.70% |
| Test 2 | | | |
| 10 M | 3.80% | 1.57% | 1.72% |
| Test 1 | | | |
| 10 M | 3.90% | 1.39% | 1.68% |
| Test 2 | | | |
| 12 M | 6.39% | 3.03% | 4.14% |
| Test 1 | | | |
| 12 M | 6.81% | 3.37% | 3.69% |
| Test 2 | | | |

### Example 9

The average settling time and number of mixing events was measured for various compositions. The tests were performed in 10 mL glass centrifuge tubes. Three milliliters of each phase were pipetted into the tube. The tubes were turned horizontally and shaken by hand for 1 minute and then returned to vertical and the phase disengagement rate observed. The time was reckoned by the formation of a “distinct” interface between the aqueous and organic phases. The distinct interface formation is a somewhat subjective decision of the observer. There are sometimes small air bubbles, for example, that persist at the interface and can last for hours or days. There can be small amounts of interfacial “crud” that form at the interface. One bulk phase or both may be cloudy presumably caused by very fine dispersed droplets of the other phase. The cloudiness often takes hours to a day to disappear. The disappearance of the last “bubbles” of mixed phase near the interface may not always be observed from one side of the tube because of the cloudiness of the bulk phases. There are often droplets of the other phase adhering to the wall of the tube present in the region of the separated bulk phase. Droplets of both phases may also adhere to the tube wall above the solution phases. It was the time of formation of the distinct interface that was being judged. NH₃ concentrations are based on diluting 30 wt % to 33 wt % ammonia in water with distilled water, with 33 wt % ammonia being about 17.2 M NH₃. The reagents tested included, but were not limited to, HDEHP is di-2-ethylhexylphosphoric acid (“HDEHP”), 1-pentanol (“POH”), and 1,2-dichlorobenzene (“1,2-DCB”). The results are shown in Table 4.

TABLE 4
Average settling time and number of mixing
events for various compositions.

| | Average | |
|---|---|---|
| | disengagement time | No. of |
| Phases | (sec) | mix events |
| Chloroform and water | 10 | 5 |
| Chloroform and 8 M LiCl | 16 | 6 |
| Chloroform and 10 M LiCl | 19 | 8 |
| Chloroform and 12 M LiCl | 49 | 14 |
| 1 M B15C5 CHCl₃ and | 263 | 6 |
| 12 M LiCl | | |
| 1 M B15C5 CHCl₃ and | 107 | 5 |
| 10 M LiCl | | |
| 1 M B15C5 CHCl₃ and | 103 | 7 |
| 8 M LiCl | | |
| 1 M B15C5 CHCl₃— | 89 | 6 |
| 17% toluene 12 M LiCl | | |
| 1 M B15C5 CHCl₃— | 130 | 3 |
| 20% toluene and | | |
| 12 M LiCl | | |
| 1 M B15C5 CHCl₃— | 56 | 6 |
| 17% toluene and | | |
| 10 M LiCl | | |
| 1 M B15C5 CHCl₃— | 63 | 6 |
| 16% toluene/10 M LiCl | | |
| 1 M B15C5 CHCl₃— | 81 | 7 |
| 10% toluene and | | |
| 10 M LiCl | | |
| 1 M B15C5 CHCl₃— | 72 | 7 |
| 20% toluene and | | |
| 10 M LiCl | | |
| 1 M B15C5 CHCl₃— | 43 | 7 |
| 17% toluene and | | |
| 8 M LiCl | | |
| 1 M B15C5 CHCl₃— | 52 | 7 |
| 16% toluene and | | |
| 8 M LiCl | | |
| 1 M B15C5 CHCl₃— | 55 | 5 |
| 20% toluene and | | |
| 8 M LiCl | | |
| 0.8M B15C5 CHCl₃— | 66 | 7 |
| 17% toluene and | | |
| 10 M LiCl | | |
| 0.8M B15C5 CHCl₃— | 52 | 7 |
| 16% toluene and | | |
| 8 M LiCl | | |

Lithium thiocyanate tests 5-6 M Li estimated

| | | |
|---|---|---|
| 1 M B15C5 CHCl₃ and | 83 | 6 |
| 5 M to 6 M LiSCN | | |
| 1 M B15C5 CHCl₃— | 91 | 5 |
| 10% toluene and | | |
| 5 M to 6 M LiSCN | | |
| 0.8M B15C5 CHCl₃, | 65 | 5 |
| 17% toluene, and | | |
| 5 M to 6 M LiSCN | | |

5.0M LiSCN solution made from LiOH and NH₄SCN

| | | |
|---|---|---|
| 1.0M B15C5 in CHCl₃—, | 60 | 5 |
| 17% toluene, and | | |
| 5 M LiSCN | | |
| 1.0M B15C5 in CHCl₃—, | 46 | 3 |
| 17% toluene, and | | |
| 4 M LiSCN | | |

### Example 10

Settling were tested for various compositions. For the settling time measurements, 3 mL of each phase in a 10 mL centrifuge tube were shaken by hand for 30 seconds and then allowed to separate. The time to formation of a “distinct” interface was timed. In many cases a second time is placed in parentheses that indicates when the last “bubbles” merged with the bulk phases. These last bubbles tended to persist to longer times with more shakes of the tube. This longer persistence time may be correlated with the appearance of a slight interfacial haze layer.

The first settling time may have been different (usually shorter) than subsequent measurements. This may have been an indication that the first shake event ends up farthest from equilibrium. Also, the PDTs tended to lengthen with sequence number for HDEHP or Cyanex 936P in heptane, but the addition of 1-pentanol to the heptane tended to make the PDTs more consistent.

The pH of the aqueous phase before shaking was 10 to 11 as measured by pH paper. After shaking the pH was 5 to 6 when the NH₃ concentration and HDEHP concentration were the same and the pH was 10 to 11 when the NH₃ concentration was several times that of the HDEHP. The 14% Cyanex 936P gave pH values of 7 to 8 after contact with an approximately equal molar concentration of NH₃ (assuming 14% Cyanex 936P can take up a maximum of 0.1 M Li), and a pH value of 10 to 11 when the NH₃ concentration was 3 to 4 times the higher. The reagents tested included, but were not limited to, HDEHP, 1-pentanol (“POH”), and 1,2-dichlorobenzene (“1,2-DCB”). The results are shown in Table 5.

TABLE 5
PDT for various compositions.

| Aqueous | Organic | PDT (sec) |
|---|---|---|
| dH₂O | 0.1M HDEHP heptane | 15; 13; 15; 15; 15 |
| dH₂O | 0.1M HDEHP | >1 h |
| | 1-pentanol | |
| 0.1M LiOH | 0.1M HDEHP heptane | >1 h |
| 0.1M NH₃ | 0.1M HDEHP heptane | >1 h |
| 0.1M LiSCN | 0.1M HDEHP heptane | 135; 125; 126 |
| 0.5M NH₃ | | |
| 0.2M LiSCN | 0.1M HDEHP heptane | 40; 55; 63; 70; 85 |
| 0.05M NH₃ | | |
| 0.2M LiSCN | 14% Cyanex heptane | 40; 55(65); 58(79); 60(91); |
| 0.05M NH₃ | | 70(105); 63; 75; 90; 90; 91 |
| (add 0.05M NH₃) | | |
| 0.2M LiSCN | 0.1M HDEHP | interface ~60 s, foam layer |
| 0.075M NH₃ | 1,2-DCB | persists >5 m |
| 0.2M LiSCN | 0.1M HDEHP heptane | 46; 46; 46; 48; 47; 58; 60; |
| 0.075M NH₃ | and 20% POH | 59; 62; 61 |
| (add 0.05M NH₃) | | |
| 0.05M LiOH 0.05M | 0.1M HDEHP heptane | >1 h |
| LiSCN | and 20% POH | |
| 0.15M LiSCN | 0.1M HDEHP heptane | 50; 50; 50; 50; 50 |
| 0.1M NH₃ | and 20% POH | |
| 0.15M LiCl | 0.1M HDEHP heptane | 40(44); 40(47); 40(48); |
| 0.1M NH₃ | and 20% POH | 40(51); 40(49) |
| 0.15M LiCl | 14% Cyanex heptane | 70(89); 75(105); 77(109); |
| 0.1M NH₃ | and 20% POH | 80(111); 80(141) |
| 0.15M LiCl | 0.1M HDEHP heptane | 50(60); 45(59); 45(57); |
| 0.1M NH₃ | and 20% POH | 45(58); 45(57); 50(70); |
| (add 0.3M NH₃) | | 57(90); 90(90); 60(95); |
| | | 64(105) |

Made new 0.500M LiCl rather than diluting 12 M stock solution

| | | |
|---|---|---|
| 0.17M LiCl | 0.1M HDEHP heptane | 34; 41(48); 41(3); 42(57); |
| 0.1M NH₃ | and 30% POH | 42(62); 47(56); 47(60); |
| (add 0.3M NH₃) | | 49(67); 50(75); 53(80) |
| 0.15M LiSCN | 0.1M HDEHP heptane | 41; 70(92); 80(110); |
| 0.1M NH₃ | and 30% POH | 80(110); 80(112) |
| 0.2M LiCl | 0.1M HDEHP heptane | 32; 33(35); 33(36); |
| 0.1M NH₃ | and 30% POH | 33(38) −37; 38(41); |
| Duplicate tubes | | 39(45); 39(45) |
| 0.2M LiCl | 0.1M HDEHP heptane | 32; 33; 35(37); |
| 0.4M NH₃ | and 30% POH | 35(40) −32; 35; |
| Duplicate tubes | | 38(41); 39(45) |
| 0.2M LiCl | 0.2M HDEHP heptane | 30; 37(45); 37(45); 38(45); |
| 0.2M NH₃ | and 30% POH | 38(45) −30; 35; |
| Duplicate tubes | | 36(43); 37(45) |
| 0.2M LiCl | 0.2M HDEHP heptane | 37(41); 38(45); 39(48); |
| 0.8M NH₃ | and 30% POH | 40(49); 40(51) −37; |
| Duplicate tubes | | 41; 39(47); 43(51) |

### Example 11

A series of experiments was run to determine a set of Cyanex extraction conditions that provided good separation time, good distribution, and good alphas. The solvent system was various concentrations of LiCl and LiOH in the aqueous layer and 28% Cyanex 936P in dodecane. Sufficient LiOH in the aqueous phase was required to maintain a high pH after the extraction. Improved distributions were obtained when the post-extraction pH of the aqueous layer was basic. About 0.19 M Li entered the organic (with 28% Cyanex) with increasing concentrations of lithium in the aqueous phase, so long as the post extraction pH remains basic. This was achieved with as little as 0.3 M to 0.4 M total lithium concentration in the aqueous with 1:1 mix of LiOH and LiCl (0.15 M LiOH:0.15 M LiCl).

The phase disengagement time of water and 100% dodecane was about 20 seconds and a 28% Cyanex and 72% dodecane organic with distilled water has a disengagement time of about 60 seconds. The disengagement time of water and 100% heptane was about 9 seconds. Distilled water and 28% Cyanex and 72% heptane had a 33 second disengagement. About 50 seconds was the best disengagement time with real extraction using 1M LiOH in 28% Cyanex and 72% dodecane. The same extraction with 28% Cyanex and 72% heptane exhibited about a 73 second disengagement time.

The effect of lithium salt and concentration on the disengagement time was assessed. If concentrations of LiOH had a long disengagement time from 0.1 M to 0.5 M, then the separation time decreased sharply from 0.5 M to 1.0 M down to a low of 50 seconds. A series of experiments was performed with a Li concentration of 0.3 M and changing the ratio of LiCl and LiOH from 0.3 M LiCl to a 1:1 (0.15 M:0.15 M). The distribution increased with increasing LiOH concentration due to the increasing post-extraction pH.

The preceding examples can be repeated with similar success by substituting the generically or specifically described reactants and/or operating conditions of this invention for those used in the preceding examples.

Note that in the specification, “about” or “approximately” means within twenty percent (20%) of the numerical amount cited. The terms, “a”, “an”, “the”, and “said” mean “one or more” unless context explicitly dictates otherwise.

Although the invention has been described in detail with particular reference to these embodiments, other embodiments can achieve the same results. Variations and modifications of the present invention will be obvious to those skilled in the art. The entire disclosures of all references, applications, patents, and publications cited above are hereby incorporated by reference.

What is claimed is:

1. A composition for extracting a metal, the composition comprising:
an organic phase;
said organic phase comprising:
a crown ether;
an organic solvent; and
an organophosphate.

2. The composition of claim 1 wherein said crown ether comprises B15C5 crown.

3. The composition of claim 2 wherein said crown ether comprises 4-tert-butylbenzo-15-crown-5.

4. The composition of claim 2 wherein said crown ether comprises a t-butyl derivative of said B15C5 crown.

5. The composition of claim 2 wherein said organic solvent comprises chloroform.

6. The composition of claim 2 wherein said organic solvent comprises toluene.

7. The composition of claim 6 wherein said toluene is at a concentration of between approximately 5% to 20% by volume.

8. The composition of claim 2 wherein said organic solvent comprises heptane.

9. The composition of claim 2 wherein said organic solvent comprises 1,2-dichlorobenzene.

10. The composition of claim 2 wherein said organophosphate comprises a liquid phosphine oxide.

11. The composition of claim 2 wherein said organophosphate comprises Cyanex 936P.

12. The composition of claim 2 wherein said organophosphate comprises di-2-ethylhexylphosphoric acid.

13. The composition of claim 2 further comprising an alcohol.

14. The composition of claim 13 wherein said alcohol comprises 1-pentanol.

15. The composition of claim 2 further comprising an aqueous phase wherein said aqueous phase comprises:
a metal salt; and
a base.

16. The composition of claim 15 wherein said metal salt comprises a lithium salt.

17. The composition of claim 15 wherein said base comprises ammonia.

18. A method for extracting a metal, the method comprising:
at least partially disposing an organic phase into a high-speed countercurrent chromatograph, wherein the organic phase comprises:
a crown ether;
an organic solvent; and
an organophosphate;
at least partially disposing an aqueous phase into the high-speed countercurrent chromatograph, wherein the aqueous phase comprises:
a metal salt; and
a base;
at least partially disposing a sample comprising a metal into the high-speed countercurrent chromatograph;
contacting the organic phase with the aqueous phase; and
extracting the metal from the aqueous phase into the organic phase.

19. The method of claim 18 wherein the metal comprises a lithium ion.

20. The method of claim 18 wherein the crown ether comprises B15C5 crown.
